(19) United States
(12) Patent Application Publication
(10) Pub. No.: US 2003/0223590 A1
(43) Pub. Date: Dec. 4, 2003

(54) Assembly for eliminating noise for microphones and method for making the same

(76) Inventor: Keng Kuei Su, Kaohsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/155,034

(22) Filed: May 28, 2002

(51) Int. Cl. H04R 3/00

(52) U.S. Cl. 381/92

(57) ABSTRACT

A method and noise eliminating device for eliminating noise for microphones includes a sound picking process by using two picking members to receive a sound and send two respective signals, a phases reversing process by transferring one signal into a signal which is reverse to the other, and an eliminating process by overlapping the two signals with reverse phases to eliminate the two signals.

### FIELD OF THE INVENTION

The present invention relates to an assembly and a method for eliminating a noise by overlapping two reverse signals caused by the noise.

### BACKGROUND OF THE INVENTION

A conventional cordless microphone 1 is shown in FIG. 1 and generally includes head 12 and a shank 11. The head 12 includes a casing 121 with a plurality of apertures 122 defined therethrough and enclosing a chamber 123 in the head 12. A sound picking device 124 is received in the casing 121 and connected to a switch 13 which is connected to an amplifier 111 received in the shank 11. A signal emitting member 2 is connected to the bottom of the shank 11 so as to emit a signal to a regulator to transfer the signal into sound. There is an inherent problem for the conventional microphone and that is the microphone could generate a huge noise especially when the microphone is hit or scraped unintentionally, or the moment when the switch 13 is pushed. This is because the sound caused by the impact to the microphone is picked by the sound picking device 124 and is amplified by the amplifier 111. Although some manufacturers mount a spring or a rubber pad connected to the sound picking device to reduce the vibration to reduce noise, it is not satisfied by the users.

### SUMMARY OF THE INVENTION

In accordance with one aspect of the present invention, there is provided a method for eliminating noise for microphones. The method comprising a sound picking process, a phases reversing process, and an eliminating process. Two sound picking members are used to pick the same sound entering the microphone and respectively send a first signal and a second signal. The phases reversing process transfers the first signal and the second signal into two signals that have reverse phases. The eliminating process overlaps the two signals with reverse phases so as to eliminate the two signals.

The present invention provides a noise eliminating device for a microphone and comprises two sound picking members, a phases reversing unit, and a overlapping unit. The two sound picking members receive the same sound and send two respective signals. The phases reversing unit is connected to an output port of the first sound picking member and reverses the phase of the signal coming from the first sound picking member. The overlapping unit is connected to an output port of the second sound picking member. The signal and the reverse signal are overlapped and eliminated.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional microphone which shows a sound picking device;

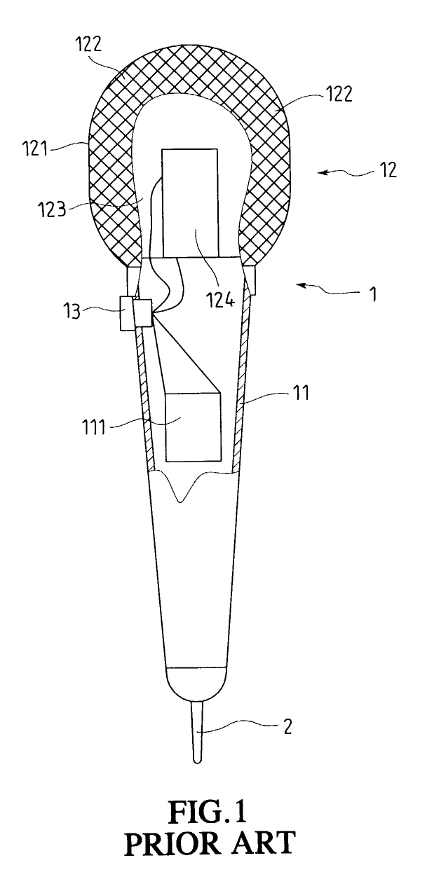

FIG. 2 shows the circuit used in the method and the device for eliminating noise of a microphone of the present invention;

FIG. 3 shows three processes of the method for eliminating noise of a microphone of the present invention, and

FIG. 4 shows the wave patterns of different sounds treated in the present invention.

### DETAILED DESCRIPTION OF THE PREFERRED EMBODIMENT

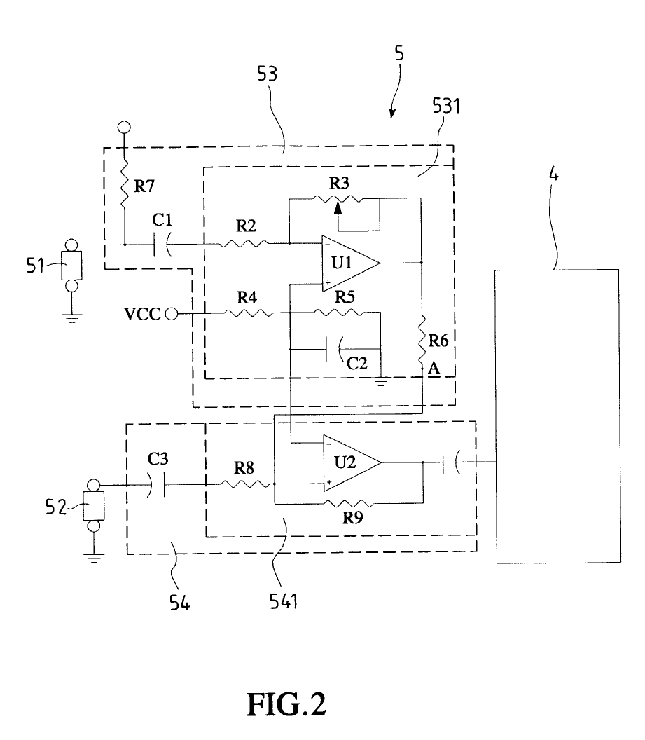

Referring to FIG. 2, the method for eliminating noise for microphones comprises a sound picking process 31, a phases reversing process 32 and an eliminating process 33. The sound picking process 31 uses a first sound picking member and a second sound picking member to respectively picking the same sound entering the microphone and respectively sent a first signal and a second signal transferred from the sound. The two signals have the same phase.

The phases reversing process 32 transfers the first signal and the second signal into two signals that have reverse phases. The first signal in the phases reversing process is rotated 180 degrees so that the reversed first signal has 180 degrees of phase difference with respect to the second signal.

The eliminating process 33 overlaps the two signals with reverse phases so as to eliminate the two signals. By this way, there will be no noise being generated from the microphone.

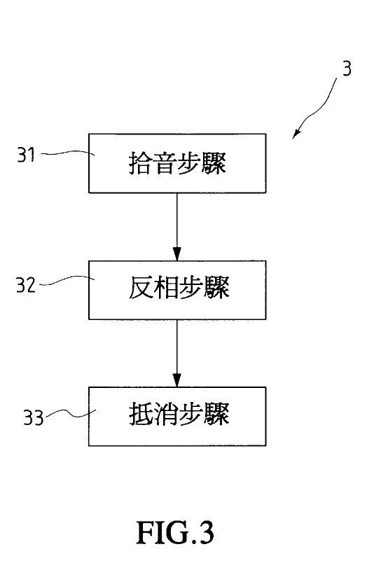

As shown in FIG. 3, the noise eliminating device 5 for a microphone is connected to an amplify circuit 4 of the microphone and includes a first sound picking member 51 and a second sound picking member 52. The first sound picking member 51 is a capacitor-type or coil-type sound picking member and is isolated from outside of the microphone so that the sound outside cannot enter the first sound picking member 51 and only the sound caused by hitting or scraping the microphone can be received by the first sound picking member 51. The second sound picking member 52 is a coil-type or capacitor-type sound picking member and communicates with outside of the microphone so that the second sound picking member 52 can receive the sound coming from the outside of the microphone and the sound caused by hitting or scraping the microphone.

The phases reversing unit 53 includes a capacitor C1 and a reverse amplify circuit 531 which is connected to the capacitor C1 and the voltage source VCC. The reverse amplify circuit 531 includes a reverse amplifier U1 and a resistor R2 which is connected between the capacitor C1 and the negative output terminal of the reverse amplifier U1, a feed-back resistor R3 is connected between the capacitor C1 and the positive output terminal of the reverse amplifier U1, two resistors R4, R5 are connected between the voltage source VCC and the positive output terminal of the reverse amplifier U1, and a capacitor C2. The reverse amplify circuit 531 employs the two resistors R4, R5 and the capacitor C2 to divide the voltage source VCC to be a direct current reference voltage for the reverse amplifier U1. The signal entering the reverse amplify circuit 531 is reversed 180 degrees and amplified by the rate of R3/R2. The feed-back resistor R3 is a variable resistor so that the rate of amplify can be adjusted by adjusting the resistance of the feed-back resistor R3.

The overlapping unit 54 includes a capacitor C3 which is connected to the second sound picking member 52, a summing member 541 connected to the capacitor C3 and the reverse amplify circuit 531. The output terminal of the summing member 541 is connected to the amplify circuit 4 of the microphone.

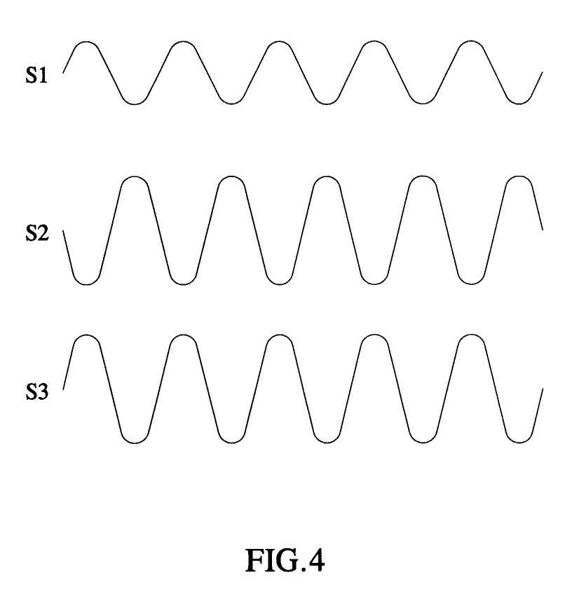

Referring FIGS. 2, 3 and 4, when a noise sound is applied to the microphone by hitting or scraping the microphone, the sound picking process 31 is activated and the noise sound is received by the first and the second sound picking member 51, 52 and a signal S1 is sent by the two sound picking members 51, 52. In the phases reversing process 32, the signal sent by the first sound picking member 51 is reaches the capacitor C1 and the reverse amplify circuit 531 and amplified at the rate of the value of R3/R2 and a reverse signal S2 is sent. There is a phase difference of 180 degrees between the signal S2 and the signals S1, S3. The S2 is the value of R3/R2 times of the S1. By adjusting the value of R3, the reverse phase signal S2 output from the point A of the reverse amplify circuit 531 I has the same pattern as the signal S3 coming from the second sound picking member 52. Besides, in the eliminating process 33, the signal S3 of the second sound picking member 52 is connected to the summing member 541 via the capacitor C3. Therefore, the reverse phase signal S2 coming from the reverse amplify circuit 531 is overlapped with the signal S3 coming from the second sound picking member 52 by the summing member 541. The S2 and S3 are eliminated to each other at the output terminal of the summing member 541, so that no noise is sent to the amplify circuit 4 of the microphone.

A sound coming from outside of the microphone can only be received by the second sound picking member 52 and a signal is sent by the second sound picking member 52 to the summing unit 54. There is no signal sent by the first sound picking member 51 which is isolated from the outside of the microphone. The phases reversing unit 53 has no signal being sent to the summing unit 54 so that the signal sent by the second sound picking member 52 can be output after being amplified by the amplify circuit 4. The present invention can be used on any type of microphones.

While we have shown and described the embodiment in accordance with the present invention, it should be clear to those skilled in the art that further embodiments may be made without departing from the scope of the present invention.

What is claimed is:

1. A method for eliminating noise for microphones, comprising:
a sound picking process: using a first sound picking member and a second sound picking member to respectively picking the same sound entering the microphone and respectively sent a first signal and a second signal transferred from the sound;
a phases reversing process: transferring the first signal and the second signal into two signals that have reverse phases, and
an eliminating process: overlapping the two signals with reverse phases and eliminating the two signals.

2. The method as claimed in claim 1 wherein the first signal in the phases reversing process is rotated 180 degrees.

3. A noise eliminating device for a microphone, comprising:
a first sound picking member and a second sound picking member, each of the two sound picking members receiving a sound and sending a signal;
a phases reversing unit connected to an output port of the first sound picking member so as to receive a signal from the first sound picking member and reversing a phase of the signal which is sent from the phases reversing unit, and
an overlapping unit connected to an output port of the second sound picking member, the phases reversing unit connected to an amplifier so as to receive the signal coming from the second sound picking member and the reverse signal coming from the phases reversing unit, the signal and the reverse signal being overlapped and eliminated.

4. The noise eliminating device for a microphone as claimed in claim 3, wherein the phase reversing unit rotates the signal 180 degrees.

5. The noise eliminating device for a microphone as claimed in claim 3, wherein the first sound picking member is isolated from the outside and the second sound picking member communicates with the outside.

6. The noise eliminating device for a microphone as claimed in claim 3, wherein the first sound picking member is a capacitor-type sound picking member and the second sound picking member is a coil-type sound picking member.

7. The noise eliminating device for a microphone as claimed in claim 3, wherein the first sound picking member is a coil-type sound picking member and the second sound picking member is a capacitor-type sound picking member.

8. The noise eliminating device for a microphone as claimed in claim 2, wherein the phases reversing unit includes a capacitor and a reverse amplify circuit connected to the capacitor of the phases reversing unit.

9. The noise eliminating device for a microphone as claimed in claim 8, wherein the overlapping unit includes a capacitor connected to the second sound picking member and a summing circuit connected to the capacitor of the overlapping unit and the reverse amplify circuit.
